(19) United States
(12) Patent Application Publication
(10) Pub. No.: US 2013/0040468 A1
(43) Pub. Date: Feb. 14, 2013

(54) REMOTE-CONTROLLED MIRROR DRIVE UNIT AND METHOD FOR ASSEMBLING REMOTE-CONTROLLED MIRROR

(71) Applicant: Masahiro MOTOMIYA, Fujieda-city (JP)

(72) Inventor: Masahiro MOTOMIYA, Fujieda-city (JP)

(73) Assignee: MURAKAMI CORPORATION, Shizuoka (JP)

(21) Appl. No.: 13/559,953

(22) Filed: Jul. 27, 2012

(30) Foreign Application Priority Data
Aug. 10, 2011 (JP) 2011-174433

(51) Int. Cl. H01R 33/00; B23P 17/04

(52) U.S. Cl. 439/34; 29/428

(57) ABSTRACT

Provided is a remote-controlled mirror drive unit, the drive unit eliminating the need to provide a splice portion that short-circuits terminals of two motors at a halfway position in a mirror harness and enabling the short-circuit part to be arranged outside a mirror unit. A mirror harness includes four wires connected respectively to four terminals of two mirror angle adjustment motors. The mirror harness is led to a vehicle body inner portion through a mirror housing and a mirror base. In the vehicle body inner portion, a mirror switch circuit is disposed. Three wires that supply drive power to the motors are drawn out from the mirror switch circuit. The four wires and the three wires are interconnected in an in-vehicle body connector. Here, two wires are connected to one wire, and two wires are individually connected to two wires.

The disclosure of Japanese Patent Application No. JP2011-174433 filed on Aug. 10, 2011 including the specification, drawings, claims and abstract is incorporated herein by reference in its entirety.

### BACKGROUND OF THE INVENTION

1. Field of the Invention

The present invention relates to a drive unit that supplies drive power to motors in a mirror angle adjustment actuator (hereinafter referred to as “actuator”) in a vehicle remote-controlled mirror whose mirror angle is electrically adjusted, the drive unit eliminating the need to provide a splice portion that short-circuits terminals of two motors at a halfway position in a mirror harness and enabling the short-circuit part to be arranged outside a mirror unit. The present invention also relates to a method for assembling a remote-controlled mirror including the drive unit.

2. Description of the Related Art

An actuator for a remote-controlled mirror includes a motor for adjusting a vertical angle of a mirror and a motor for adjusting a horizontal angle of the mirror. A power feed channel that supplies drive power to these two motors includes a total of three wires, i.e., two wires individually connected to respective first terminals of the two motors and one wire connected in common to respective second terminals of the two motors for short-circuiting the second terminals each other, the three wires being connected to three wires installed on the vehicle body side via a connector (see FIG. 8 in Japanese Patent Laid-Open No. 2004-66892).

As an example of the structure in which one wire is connected in common to the respective other terminals of the two motors, there is one illustrated in FIG. 10 in Japanese Patent Laid-Open No. 2004-66892. The structure is illustrated in FIGS. 13A and 13B. FIG. 13A illustrates a right door mirror. An actuator 12 is included in a housing 11 of a door mirror 10. The actuator 12 includes two motors 14 and 16 therein. Two long wires 18 and 20 are connected to respective first terminals of the motors 14 and 16. Two short wires 22 and 24 are connected to respective second terminals of the motors 14 and 16. End portions of the wires 22 and 24 are connected in common to one separately-provided wire 26 at a connection point P. A mirror harness 28 resulting from bundling the three wires 18, 20 and 26 provided as described above is led to the vehicle body side via a mirror base 30 of the door mirror 10. In the vicinity of a driver's seat on the vehicle body side, a mirror angle adjustment controller 32 for a driver to remotely control the mirror angles is disposed. A vehicle body harness 40 resulting from bundling three wires 34, 38 and 36 is drawn out from the mirror angle adjustment controller 32. The mirror harness 28 and the vehicle body harness 40 are interconnected via a connector 42, whereby connecting the wires 18 and 34, the wires 20 and 36, and the wires 26 and 38 in the harnesses 28 and 40 to each other, respectively.

In remote-controlled mirrors, even if actuators of a same type of are used, terminals to be short-circuited of motors may differ depending on the difference between left and right mirrors or the difference between the vehicle types. For example, in the aforementioned door mirrors in FIGS. 13A and 13B, which are described in Japanese Patent Laid-Open No. 2004-66892, in the right mirror in FIG. 13A, the wires 22 and 24 are connected in common to the wire 26 at the connection point P, and in the left mirror in FIG. 13B, wires 22 and 20 are connected in common to a wire 26 in a connection point Q. In general, splices (crimp terminals) are used for the wire connections at the connection points P and Q. In other words, coatings of extremity portions of the respective three wires, which are to be interconnected, are removed to make conductors be exposed, and the exposed conductors are interconnected each other by means of crimping using one splice, and then the connected parts are covered by a vinyl tape to form a splice portion.

Formation of a splice portion at a halfway position in a mirror harness is manually performed, resulting in poor productivity. As an example of a remote-controlled mirror eliminating the need to provide a splice portion at a halfway position in a mirror harness, there is one illustrated in FIG. 1 in Japanese Patent Laid-Open No. 2004-66892 (hereinafter reference numerals in parentheses are those indicated in Japanese Patent Laid-Open No. 2004-66892). In such remote-controlled mirror, a structure that short-circuits terminals of motors (20 and 22) is arranged inside an actuator connector (36) attached to an actuator-side end portion of a mirror harness in order to connect the mirror harness to the actuator (18). In other words, two types of conductors (64 and 66) that are to be each included in an actuator connector (36) and each short-circuit two wires are prepared, and terminals to be short-circuited of the motors (20 and 22) are changed depending on which conductor (64 or 66) is included in the actuator connector (36).

As another example of the remote-controlled mirror eliminating the need to provide a splice portion at a halfway position in a mirror harness, there is a remote-controlled mirror described in Japanese Patent Utility Model Laid-Open No. 6-3738 (hereinafter, reference numerals in parentheses are those indicated in Japanese Patent Utility Model Laid-Open No. 6-3738). In such remote-controlled mirror, a connector (36) is housed in an actuator (5). The connector (36) includes three power supply-side terminals (37, 38 and 39) and three motor-side terminals (40, 41 and 42) electrically each connected to an individual one of the three power supply-side terminals (37, 38 and 39). One terminals (44 and 52) of two motors (M1 and M2) are connected to the individual motor-side terminals (40 and 42) of the connector (36) via individual wires (45 and 53), and other terminals (47 and 50) of the two motors (M1 and M2) are connected in common to the remaining one motor-side terminal (41) via individual wires (48 and 51). The three power supply-side terminals (37, 38 and 39) of the connector (36) are exposed outside a case (15) of the actuator (5). A mirror harness (61) includes a bundle of three wires, and extremity portions of these three wires are connected to one coupler (60). The coupler (60) is connected to the power supply-side terminals (37, 38 and 39) of the connector (36) exposed outside the case (15) of the actuator (5), thereby the three wires in the mirror harness (61) each being electrically connected to an individual one of the three power supply-side terminals (37, 38 and 39) of the connector (36). Another end of the mirror harness (61) is led to the vehicle body side via a mirror base (1) of the door mirror.

As a still another example of the remote-controlled mirror eliminating the need to provide a splice portion at a halfway position in a mirror harness, there is a remote-controlled mirror described in Japanese Patent Laid-Open No. 2006-88788 (hereinafter reference numerals in parentheses are those indicated in Japanese Patent Laid-Open No. 2006-88788). In the remote-controlled mirror, an adapter (20) is housed in an actuator (A). The adapter (20) includes three power supply-side terminals (female terminals) (23a, 23b and 23c) and four motor-side terminals (female terminals) (22a, 22b, 22c and 22d). In the adapter (20), conductors (24a and 24c) individually connecting two power supply-side terminals (23a and 23c) and two motor-side terminals (22a and 22c), and conductors (24b, 24d and 24e) connecting two remaining motor-side terminals (22b and 22d) in common to one remaining power supply-side terminal (23b) are housed. The adapter (20) is mounted on and thereby supported by two motors (10A and 10B) by inserting a total of four terminals (male terminals) (13Aa, 13Ab, 13Ba and 13Bb) of the two motors (10A and 10B) individually into the four motor-side terminals (22a, 22b, 22c and 22d). Meanwhile, a mirror harness (30) includes a bundle of three wires (31a, 31b and 31c), and end portions of the three wires (31a, 31b and 31c) are connected to individual terminals (male terminals) (33a, 33b and 33c). The three terminals (33a, 33b and 33c) are attached to one connector (32). The connector (32) is mounted on and thereby supported by the adapter (20) by inserting the three terminals (33a, 33b and 33c) into the three power supply-side terminals (23a, 23b and 23c) of the adapter (20), whereby each of the three wires (31a, 31b and 31c) in the mirror harness (30) is electrically connected to an individual one of the three power supply-side terminals (23a, 23b and 23c) of the adapter (20). The mirror harness (30) is led to the vehicle body side via a mirror base of the door mirror.

Although the aforementioned remote-controlled mirrors described in FIG. 1 of Japanese Patent Laid-Open No. 2004-66892 and Japanese Patent Utility Model Laid-Open No. 6-3738 and Japanese Patent Laid-Open No 2006-88788 eliminate the need to provide a splice portion at a halfway position in a mirror harness, each of the remote-controlled mirrors includes the short-circuit part inside the mirror unit. Thus, it is necessary to finish a short-circuit structure before an actuator and a mirror harness are incorporated into a mirror unit. With the remote-controlled mirrors, as described above, even if actuators of a same type are used, terminals to be short-circuited of motors differ depending on the difference between the left and right mirrors or the difference in vehicle type, and thus, if wrong terminals to be short-circuited are erroneously incorporated in the mirror unit and such error is found out in a subsequent operation check test, it is necessary to disassemble the mirror unit, correct the short-circuit structure and then assembles the mirror unit again, requiring troublesome correction work. Also, even if actuators of a same type and a mirror harnesses of a same type are used in left and right mirrors or in different types of vehicles, actuator-mirror harness combinations with a finished short-circuit structure therein are prepared, classified and managed according to the left and right mirrors or the vehicles types before the actuators and the mirror harnesses are incorporated into mirror units, requiring troublesome management.

The present invention has been made in view of the aforementioned problems, and is intended to provide a drive unit for a remote-controlled mirror, the drive unit eliminating the need to provide a splice portion that short-circuits terminals of two motors at a halfway position in a mirror harness and enabling a short-circuit part to be arranged outside a mirror unit. Also, the present invention is intended to provide a method for assembling a remote-controlled mirror including such drive unit.

### SUMMARY OF THE INVENTION

A remote-controlled mirror drive unit according to the present invention includes a remote-controlled mirror drive unit for supplying drive power to two direct-current motors in a mirror angle adjustment actuator in a vehicle remote-controlled mirror to electrically adjust a mirror angle vertically and horizontally, the drive unit including: a mirror harness including four wires individually connected to four terminals of the two motors, the mirror harness being installed from an inner portion of a mirror housing of the remote-controlled mirror to an inner portion of a vehicle body through a mirror base; a vehicle body harness including three wires including a first wire, a second wire and a third wire, the vehicle body harness being installed in the inner portion of the vehicle body; a mirror switch circuit disposed in the inner portion of the vehicle body, to which power supply-side end portions of the three wires of the vehicle body harness are connected, the mirror switch circuit applying a motor drive voltage between the first wire and the second wire or between the first wire and the third wire from among the three wires selectively and with a polarity of the voltage reversibly changed according to a mirror angle adjustment operation of a mirror angle adjustment controller by a user; and an in-vehicle body connector that interconnects four wires in the mirror harness and the three wires in the vehicle body harness, the connector including a mirror harness-side part to which terminal fittings of the four wires in the mirror harness are attached and a vehicle body harness-side part to which terminal fittings of the three wires in the vehicle body harness are attached, the in-vehicle body connector providing an electric conducting channel in which two of the four terminal fittings of the four wires in the mirror harness are connected in common to a terminal fitting of the first wire in the vehicle body harness, and remaining two of the four terminal fittings of the four wires in the mirror harness are individually connected to the second wire and the third wire in the vehicle body harness when the mirror harness-side part and the vehicle body harness-side part are interconnected.

With the drive unit, connection between the mirror harness-side part and the vehicle body harness-side part of the in-vehicle body connector provides a short-circuit structure, eliminating the need to provide a splice portion at a halfway position in a mirror harness. Also, the short-circuit part can be arranged outside the mirror unit. Accordingly, the short-circuit structure is set outside the mirror unit after an actuator and a mirror harness are incorporated into the mirror unit, and thus, where actuators of a same type and mirror harnesses of a same type are used in left and right mirrors or different types of vehicles, even if a short-circuit structure differs between the left and right mirrors or between the different types of vehicles, there is no need to prepare, classify and manage actuator-mirror harness combinations with a finished short-circuit structure therein according to the left and right mirrors or the vehicle types before the actuators and the mirror harnesses are incorporated into mirror units, enabling easy management. Also, even if it is found out in an operation check after assembly of a mirror unit that wrong terminals are short-circuited, the short-circuit structure can be corrected in the part of an in-vehicle body connector without disassembling the mirror unit, enabling easy correction work.

A remote-controlled mirror assembly method according to the present invention includes a method for assembling a remote-controlled mirror including a drive unit according to the present invention, the method includes: a first step of inserting the mirror harness with the mirror harness-side part of the in-vehicle body connector not attached thereto through a hollow shaft that provides a shaft of rotation of the mirror housing relative to the mirror base, connecting an end portion on the mirror housing side of the mirror harness to the mirror angle adjustment actuator and mounting the mirror angle adjustment actuator in the inner portion of the mirror housing; and a second step of after the first step, attaching an end on the vehicle body inner portion side of the mirror harness to the mirror harness-side part of the in-vehicle body connector to set two wires connected in common to the first wire in the vehicle body harness, and two wires individually connected to the second wire and the third wire in the vehicle body harness. According to the assembly method, a short-circuit structure can be set outside a mirror unit after an actuator and a mirror harness are incorporated into the mirror unit, and thus, where actuators and mirrors that are common between left and right mirrors or between different types of vehicles are used, even if a short-circuit structure is different between the left and right mirrors or between the different types of vehicles, there is no need to prepare, classify and manage actuator-mirror harness combinations with a finished short-circuit structure therein according to the left and right mirrors or the vehicle types before the actuators and the mirror harnesses are incorporated into mirror units, enabling easy management.

### BRIEF DESCRIPTION OF THE DRAWINGS

FIG. 1 is a circuit diagram illustrating an embodiment of a drive unit according to a remote-controlled mirror of the present invention, and illustrates a left mirror-side part;

FIG. 2 is an exploded perspective diagram illustrating an example configuration of the mirror harness-side part 92A of the in-vehicle body connector 92 in FIG. 1;

FIG. 3 is a perspective diagram illustrating a state in which the mirror harness-side part 92A in FIG. 2 has been assembled;

FIG. 4A is a plan view of the mirror harness-side part 92A in FIG. 3, and FIG. 4B is a cross-sectional diagram of FIG. 4A along arrows A-A;

FIG. 5A is a side view of the mirror harness-side part 92A in FIG. 3, and FIG. 5B is a cross-sectional view of FIG. 5A along arrows B-B;

FIG. 6 is a diagram illustrating example configurations of the mirror harness-side part 92A and the vehicle body harness-side part 92B of the in-vehicle body connector 92 in FIG. 1 (the mirror harness-side part 92A is the same as those illustrated in FIGS. 2 to 5), which is a cross-sectional view of the mirror harness-side part 92A and the vehicle body harness-side part 92B cut at a position corresponding to the position indicated by arrows B-B in FIG. 5A, and illustrates the parts 92A and 92B before the parts 92A and 92B are interconnected;

FIG. 7 is a diagram illustrating the mirror harness-side part 92A and the vehicle body harness-side part 92B of the in-vehicle body connector 92 in FIG. 6, which are interconnected, and is a cross-sectional view of the mirror harness-side part 92A and the vehicle body harness-side part 92B cut at a position that is the same as that in FIG. 6;

FIG. 8A is a front view illustrating an arranged position (a posture of arrangement) of an actuator for a right mirror and FIG. 8B is a front view illustrating an arranged position (a posture of arrangement) of an actuator for a left mirror, which are arranged in a certain type of vehicle when actuators of a same type are used in the right and left mirrors;

FIG. 9 is a chart indicating settings for connection between four terminals of two motors in the left and right mirrors in FIG. 8 and three terminals of a mirror switch circuit;

FIG. 10 is a chart indicating settings for connection between two terminals on the power supply side and three terminals on the actuator side of a mirror switch circuit when connection between motors and a mirror switch is set as illustrated in FIG. 9 (the chart means that terminals connected via respective lines are interconnected);

FIG. 11 is a chart indicating settings for connection between four terminals of two motors in left and right mirrors and three terminals of a mirror switch circuit when the actuators in FIG. 8 are used in left and right mirrors of another type of vehicle;

FIG. 12 is a chart indicating settings for connection between two terminals on the power supply side and three terminals on the actuator side of a mirror switch circuit when connection between motors and a mirror switch is set as illustrated in FIG. 11 (the chart means that terminals connected via respective lines are interconnected); and

FIGS. 13A and 13B are circuit diagrams of a remote-controlled mirror drive unit described in Japanese Patent Laid-Open No. 2004-66892, and FIG. 13A is a circuit diagram of a right mirror and FIG. 13B is a circuit diagram of a left mirror.

### DETAILED DESCRIPTION OF THE PREFERRED EMBODIMENT

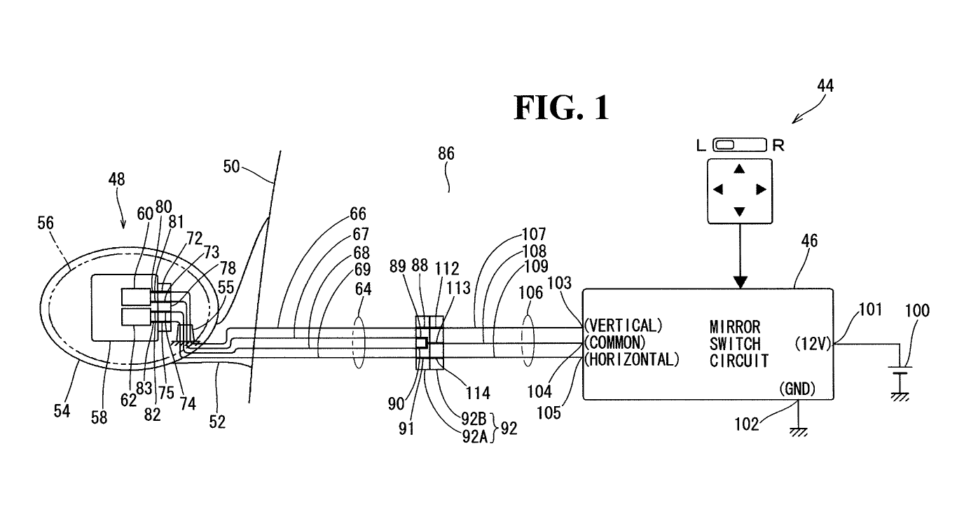

Hereinafter, an embodiment of the present invention will be described. FIG. 1 illustrates a left mirror-side part of remote-controlled mirrors to which the present invention is applied. A right mirror-side part of the same is similar to the left mirror-side part with a mirror angle adjustment controller 44 and a mirror switch circuit 46 shared with the left mirror-side part. A left door mirror 48 is provided by fixing a mirror base 52 to an outer surface of a vehicle body (left-side door) 50 and making a mirror housing 54 be supported by the mirror base 52 in such a manner that the mirror housing 54 can be moved between a retracted position (not-in-use position) and a returned position (in-use position). Inside the mirror housing 54, an actuator 58 that supports a mirror plate 56 and electrically adjusts a mirror angle of the mirror plate 56 vertically and horizontally is arranged. The actuator 58 includes two direct-current motors 60 and 62 therein. The motor 60 adjusts a vertical mirror angle of the mirror plate 56 via a transmission mechanism (not illustrated), and the motor 62 adjusts a horizontal mirror angle of the mirror plate 56 via a transmission mechanism (not illustrated).

Terminal fittings 72, 73, 74 and 75 such as crimp terminals are attached respectively to door mirror-side ends of four power supply coated wires (hereinafter referred to as “wires”) 66, 67, 68 and 69 included in a mirror harness 64. The terminal fittings 72 to 75 are attached to an actuator connector 78. The actuator connector 78 is detachably attached to the actuator 58 from the outside of an enclosure of the actuator 58. Consequently, the terminal fittings 72 and 73 of the wires 66 and 67 are attached respectively to terminals 80 and 81 of the motor 60, and the terminal fittings 74 and 75 of the wires 68 and 69 are connected respectively to terminals 82 and 83 of the motor 62.

The mirror harness 64 is installed from an inner portion of the mirror housing 54 to a vehicle body inner portion 86 through a hollow shaft 55 that provides an axis of rotation of the mirror housing 54 relative to the mirror base 52, and further through the mirror base 52. Terminal fittings 88, 89, 90 and 91 having a same structure such as crimp terminals are attached respectively to vehicle body-side ends of the wires 66, 67, 68 and 69 included in the mirror harness 64. These terminal fittings 88 to 91 are detachably attached to a mirror harness-side part 92A of an in-vehicle body connector 92. In the harness-side part 92A of the in-vehicle body connector 92, four mounting spaces that receive and mount the terminal fittings 88 to 91 to mount the terminal fittings 88 to 91 therein are formed. The terminal fittings 88 to 91 are received and mounted in proper spaces in these four mounting. Two mounting spaces from among the four mounting spaces include a structure that short-circuits two terminal fittings received in the two mounting spaces.

In the vehicle body inner portion 86, a mirror angle adjustment controller 44 and a mirror switch circuit 46 are installed. The mirror angle adjustment controller 44 is operated when a driver adjusts a mirror angle. With the mirror angle adjustment controller 44, an operation to provide an instruction to vertically change a mirror angle and an operation to provide an instruction to horizontally change the mirror angle can be performed for each of left and right mirrors. The mirror switch circuit 46 serves to supply drive power to two motors in an actuator of each of the left and right mirrors according to the operation of the mirror angle adjustment controller 44 to change the mirror angle in a direction according to the instruction. The mirror switch circuit 46 includes a 12V terminal 101 connected to a positive electrode of a 12V battery 100 and a GND terminal 102 connected to a negative electrode of the 12V battery 100. The mirror switch circuit 46 also includes a vertical adjustment terminal 103 connected exclusively to one terminal of the vertical mirror angle adjustment motor 60, a horizontal adjustment terminal 105 connected exclusively to one terminal of the horizontal mirror angle adjustment motor 62 and a common terminal 104 connected in common to respective other terminals of the motors 60 and 62 as terminals that supply power to the actuator 58 of the left door mirror 48.

Upon an instruction for a vertical mirror angle adjustment being provided by the mirror angle adjustment controller 44, the mirror switch circuit 46 connects the vertical adjustment terminal 103 to the 12V terminal 101 or the GND terminal 102 and connects the common terminal 104 to the GND terminal 102 or the 12V terminal 101 according to the direction of the movement (upward or downward) to drive the motor 60 normally or reversely, thereby changing the mirror angle in a direction according to the instruction. In this case, the horizontal adjustment terminal 105 is connected to none of the 12V terminal 101 and the GND terminal 102 and is in an open state. Also, upon an instruction for a horizontal mirror angle adjustment being provided by the mirror angle adjustment controller 44, the mirror switch circuit 46 connects the horizontal adjustment terminal 105 to the 12V terminal 101 or the GND terminal 102 and connects the common terminal 104 to the GND terminal 102 or the 12V terminal 101 according to the direction of the movement (leftward or rightward) to drive the motor 62 normally or reversely, thereby changing the mirror angle in a direction according to the instruction. In this case, the vertical adjustment terminal 103 is connected to none of the 12V terminal 101 and the GND terminal 102 and is in an open state. Also, when the mirror angle adjustment controller 44 is not operated, the mirror switch circuit 46 connects the vertical adjustment terminal 103, the horizontal adjustment terminal 105 and the common terminal 104 to none of the 12V terminal 101 and the GND terminal 102, and all of the vertical adjustment terminal 103, the horizontal adjustment terminal 105 and the common terminal 104 are in an open state.

Three wires 107, 108 and 109 included in a vehicle body harness 106 are respectively drawn out from the vertical adjustment terminal 103, the common terminal 104 and the horizontal adjustment terminal 105 of the mirror switch circuit 46. Terminal fittings 112, 113 and 114 such as crimp terminals are attached to extremity portions of the wires 107 to 109. These terminal fittings 112 to 114 are attached to a vehicle body harness-side part 92B of the in-vehicle body connector 92. The mirror harness-side part 92A and the vehicle body harness-side part 92B of the in-vehicle body connector 92 are detachably interconnected. Upon the connector parts 92A and 92B being interconnected, the terminal fittings 88 and 112 are interconnected, the terminal fittings 89, 90 and 113 are interconnected, and the terminal fittings 91 and 114 are interconnected, thereby the wires 66 and 107 being interconnected, the wires 67, 68 and 108 being interconnected, and the wires 69 and 109 being interconnected.

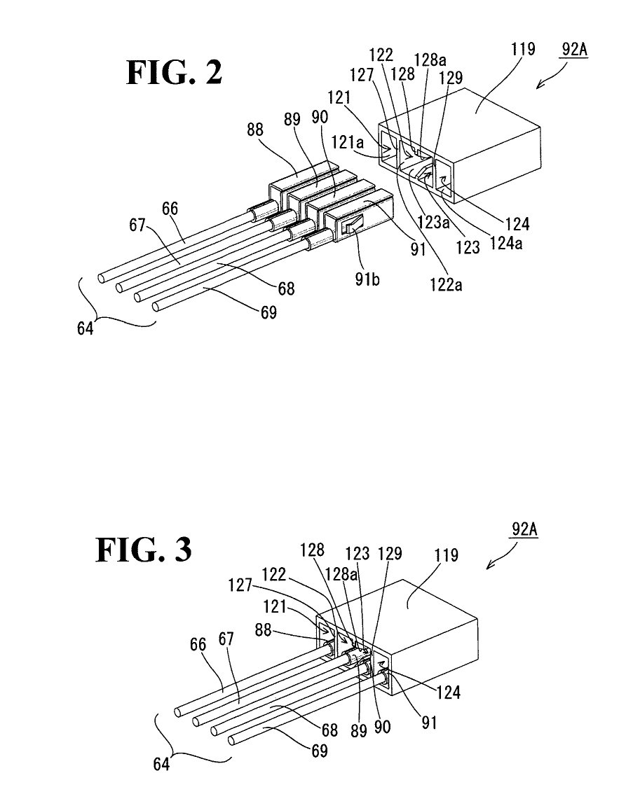

An example configuration of the in-vehicle body connector 92 will be described with reference to FIGS. 2 to 7. FIG. 2 illustrates the mirror harness-side part 92A of the in-vehicle body connector 92. The terminal fittings 88 to 91 included in the mirror harness 64, which are each formed of a crimp terminal, are attached respectively to the vehicle body-side end portions of the wires 66 to 69. The terminal fittings 88 to 91 are formed of female terminals having structures that are identical to one another and include respective insertion spaces 88a to 91a (FIG. 5(b)). A part of a side surface on a same side of each of the terminal fittings 88 to 91 is cut and supported in a cantilevered manner to form a spring contact piece 88b, 89b, 90b or 91b (FIG. 5(b)). The mirror harness-side part 92A of the in-vehicle body connector includes an enclosure 119 formed of a resin. Inside the enclosure 119, four mounting spaces 121, 122, 123 and 124 are arranged in parallel and at regular intervals. Front end portions and rear end portions in an axis direction of the mounting spaces 121 to 124 are opened. The mounting spaces 121 to 124 are separated by walls 127 to 129. A wall 128 includes a cut 128a that short-circuits the terminal fittings 89 and 90.

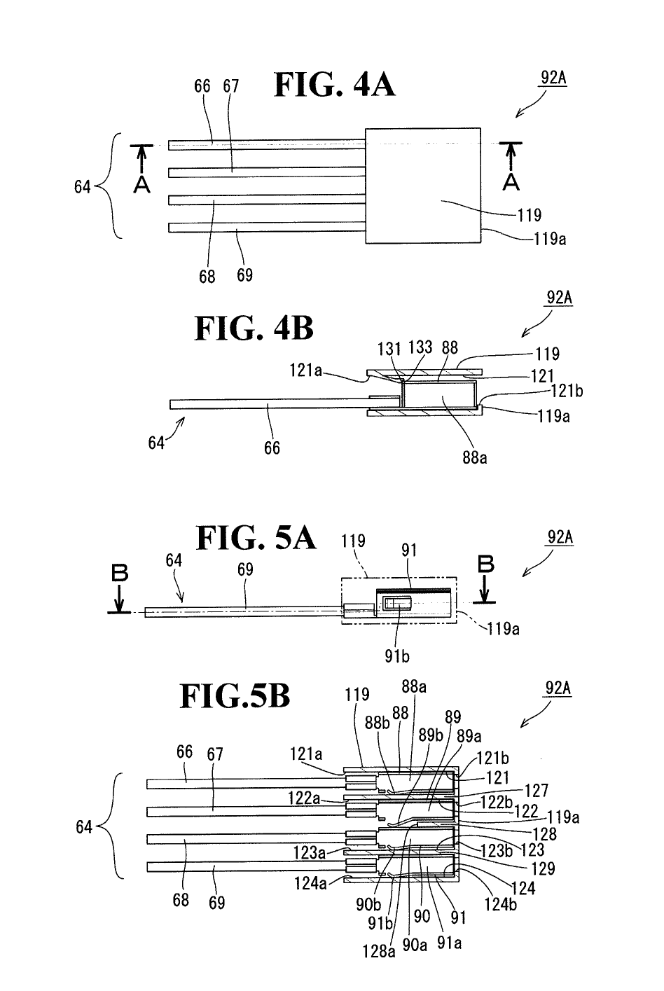

The terminal fittings 88 to 91 attached to the extremities of the wires 66 to 69 are inserted from rear opening portions 121a to 124a of the mounting spaces 121 to 124 and received in the mounting spaces 121 to 124, respectively. As illustrated in FIGS. 4B and 5B, the inserted terminal fittings 88 to 91 are stopped when front end surfaces of the terminal fittings 88 to 91 abut against a back surface of a front plate 119a of the enclosure 119. The front plate 119a includes insertion slots 121b to 124b that communicate with the insertion spaces 88a to 91a of the terminal fittings 88 to 91, respectively. As illustrated in FIG. 4B, a retaining piece 131 supported in a cantilevered manner is formed on an inner peripheral surface of each of the mounting spaces 121 to 124. Upon the terminal fittings 88 to 91 are received in the mounting spaces 121 to 124, the retaining pieces 131 in the mounting spaces 121 to 124 abut against respective rear-end corner portions 133 of the terminal fitting 88 to 91. Consequently, the terminal fittings 88 to 91 are prevented from coming off from the mounting spaces 121 to 124. With the terminal fittings 88 to 91 received and mounted in the mounting spaces 121 to 124, by retracting the retaining pieces 131 by inserting an thin stick-like piece from the rear opening portions 121a to 124a of the mounting spaces 121 to 124, the locking between the retaining pieces 131 and the terminal fittings 88 to 91 can be cancelled, enabling the terminal fittings 88 to 91 to be individually pulled out from the mounting spaces 121 to 124. The positions where the terminal fittings 88 to 91 are mounted in the mounting spaces 121 to 124 are arbitrarily interchanged, enabling mounting responsive to a difference between the left and the right mirror or a difference in vehicle type.

As illustrated in FIG. 5B, when the terminal fittings 88 to 91 are received in the mounting spaces 121 to 124, the spring contact piece 89b of the terminal fitting 89 abuts against a side surface of the terminal fitting 90 adjacent to the terminal fitting 89 through the cut 128a of the wall 128, whereby the terminal fittings 89 and 90 are short-circuited. Since the spring contact pieces 88b and 90b of the terminal fittings 88 and 90 abut against the walls 127 and 129 with no cut, the terminal fittings 88 and 90 are not in contact with other terminal fittings. The spring contact piece 91b of the terminal fitting 91, which is located at a side, abuts against an inner wall surface of the enclosure 119 and is not in contact with another terminal fitting.

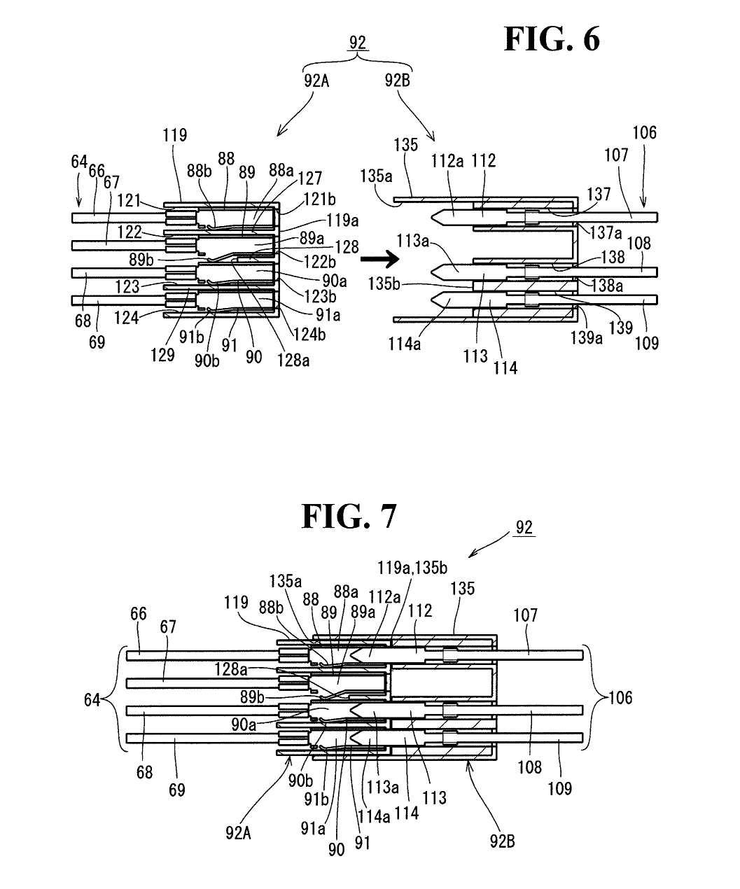

FIG. 6 illustrates the mirror harness-side part 92A and the vehicle body harness-side part 92B of the in-vehicle body connector 92 before the mirror harness-side part 92A and the vehicle body harness-side part 92B are interconnected. The terminal fittings 112 to 114, which are each formed of a crimp terminal, are attached to the respective ends of the wires 107 to 109 included in the vehicle body harness 106. The terminal fittings 112 to 114 are formed of male terminals having structures that are identical to one another and have projecting pins 112a to 114a, respectively. The vehicle body harness-side part 92B includes an enclosure 135 formed of a resin. An inner portion of the enclosure 135 is separated so that three mounting spaces 137, 138 and 139 are arranged in parallel. The mounting spaces 137, 138 and 139 face the mounting spaces 121, 123 and 124 of the mirror harness-side part 92A, respectively. Front end portions and rear end portions in an axis direction of the mounting space 137 to 139 are opened. A front end portion of the enclosure 135 include an opening portion 135a into which the mirror harness-side part 92A is inserted to connect the mirror harness-side part 92A to the vehicle body harness-side part 92B.

The terminal fittings 112 to 114 attached to the extremities of the wires 107 to 109 are inserted from rear end opening portions 137a to 139a of the mounting spaces 137 to 139 and received in the mounting spaces 137 to 139, respectively. Inside the mounting spaces 137 to 139, respective stoppers (not illustrated) are provided, and halfway portions of the terminal fittings 112 to 114 abut against the respective stoppers, whereby the inserted terminal fittings 112 to 114 are stopped. In each of inner peripheral surfaces of the mounting spaces 137 to 139, a retaining piece (not illustrated) is provided. Upon the terminal fittings 112 to 114 being inserted into the mounting spaces 137 to 139, the respective retaining pieces in the mounting spaces 137 to 139 engage with predetermined positions of the terminal fittings 112 to 114, whereby the terminal fittings 112 to 114 are prevented from coming off from the mounting spaces 137 to 139. When the terminal fittings 112 to 114 are received in the mounting spaces 137 to 139, the projecting pins 112a to 114a of the terminal fittings 112 to 114 project from the mounting spaces 137 to 139 inside the enclosure 135.

Upon the enclosure 119 of the mirror harness-side part 92A being inserted into the opening portion 135a of the enclosure 135 of the vehicle body harness-side part 92B from the state before connection in FIG. 6, the projecting pins 112a, 113a and 114a of the terminal fitting 112, 113, 114 are inserted into the insertion space 88a, 90a and 91a of the terminal fittings 88, 90 and 91 from the insertion slots 121b, 123b and 124b provided in the front plate 119a of the enclosure 119. Consequently, as illustrated in FIG. 7, the terminal fittings 88 and 112 are interconnected, the terminal fittings 90 and 113 are interconnected, and the terminal fittings 91 and 114 are interconnected. Also, since the terminal fittings 89 and 90 are short-circuited via the spring contact piece 89b of the terminal fitting 89, the terminal fittings 89, 90 and 113 are interconnected. The mirror harness-side part 92A inserted into the vehicle body harness-side part 92B is stopped when the front plate 119a of the enclosure 119 of the mirror harness-side part 92A abuts a bottom surface 135b inside the opening portion 135a of the enclosure 135 of the vehicle body harness-side part 92B. At the stopped position, a known engagement structure (not illustrated) including, e.g., a hook portion provided in one of the enclosures 119 and 135 and a hook engaging portion provided in the other of the enclosures 119 and 135 enters an engaged state, whereby the connection between mirror harness-side part 92A and the vehicle body harness-side part 92B is retained. The engaged state of the engagement structure can be cancelled manually to separate the mirror harness-side part 92A and the vehicle body harness-side part 92B from each other, enabling disconnection between the mirror harness-side part 92A and the vehicle body harness-side part 92B.

Here, a specific example of settings for connection between four terminals of two motors and three terminals of a mirror switch circuit (the vertical adjustment terminal 103, the horizontal adjustment terminal 105 and the common terminal 104 of the mirror switch circuit 46 in FIG. 1) where actuators of a same type are used between left and right mirror and between different types of vehicles. The connection settings can be made by selection of positions into which the terminal fittings 88 to 91 of the mirror harness 64 are inserted in the mounting spaces 121 to 124 of the mirror harness-side part 92A of the in-vehicle body connector 92.

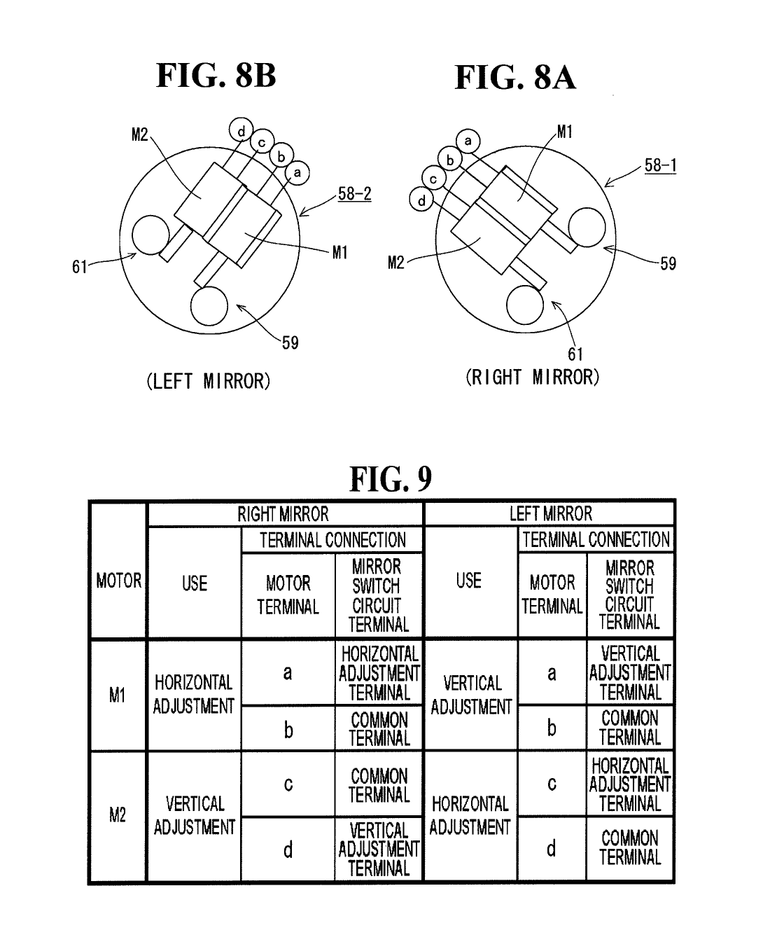

First, arranged positions (postures of arrangement) of actuators arranged in a certain type of vehicle are illustrated in FIGS. 8A and 8B. A right mirror and a left mirror use actuators 58-1 and 58-2 of a same type, respectively. For the actuators 58-1 and 58-2, known ones can be used. The actuators 58-1 and 58-2 each include two motors M1 and M2 (corresponding to the motors 60 and 62 in FIG. 1) and transmission mechanisms 59 and 61 including worm gears, and the motors M1 and M2 are driven to incline a mirror plate relative to two axes intersecting perpendicularly to each other. The arranged position of the actuator 58-2 of the left mirror is set to a position rotated clockwise by 90 degrees relative to the arranged position of the actuator 58-1 of the right mirror. Use of the actuator 58-2 rotated by 90 degrees compared with the actuator 58-1 makes an operation to move the right mirror upward or downward be equal to an operation to move the left mirror rightward or leftward, and makes an operation to move the right mirror rightward or leftward be equal to an operation to move the left mirror downward or upward. The settings for connections of the terminals are made so that a relevant operation is performed according to a direction in which a mirror angle adjustment controller is operated.

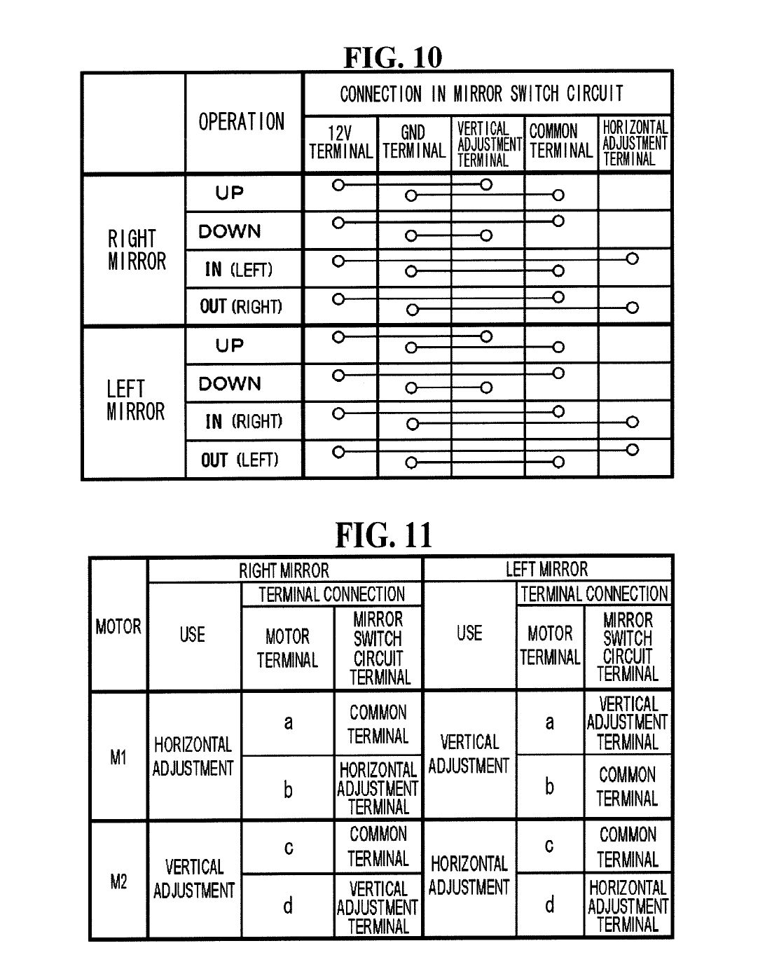

Here, it is assumed that a and b are terminals of the motor M1 and c and d are terminals of the motor M2. FIG. 9 illustrates settings for connection between four terminals a, b, c and d of the motors M1 and M2 in the right mirror and three terminals (a vertical adjustment terminal, a horizontal adjustment terminal and a common terminal) of a mirror switch circuit. Also, FIG. 10 illustrates settings for connection between two power supply-side terminals (the 12V terminal 101 and the GND terminal 102 in FIG. 1) and three actuator-side terminals (the vertical adjustment terminal 103, the horizontal adjustment terminal 105 and the common terminal 104 in FIG. 1) in the mirror switch circuit. The connection settings in FIGS. 9 and 10 enables a mirror angle adjustment of each of the left and right mirrors by changing the mirror angle in a direction corresponding to a direction to which a mirror angle adjustment controller is operated.

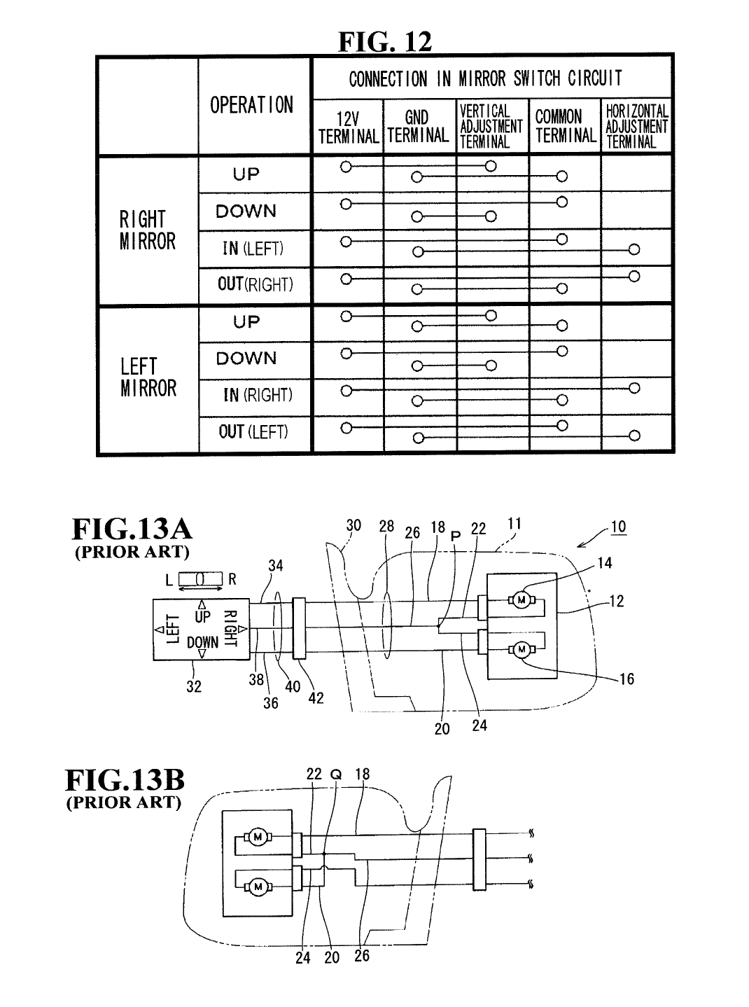

Next, terminal connection settings in another type of vehicle will be described. Arranged positions of actuators 58-1 and 58-2 arranged in left and right mirrors are the same as those in FIG. 8. FIG. 11 illustrates settings for connection between four terminals a, b, c and d of the motors M1 and M2 in the right mirror and three terminals (a vertical adjustment terminal, a horizontal adjustment terminal and a common terminal) of a mirror switch circuit. Also, FIG. 12 illustrates settings for connection between two power supply-side terminals (the 12V terminal 101 and the GND terminal 102 in FIG. 1) and three actuator-side terminals (the vertical adjustment terminal 103, the horizontal adjustment terminal 105 and the common terminal 104 in FIG. 1) in the mirror switch circuit. The connection settings in FIGS. 11 and 12 enables a mirror angle adjustment of each of the left and right mirrors by changing the mirror angle in a direction corresponding to a direction to which a mirror angle adjustment controller is operated.

An example of steps in a method for assembling a remote-controlled mirror including the drive unit in FIG. 1 will be described.

(1) The actuator connector 78 is attached to one end of the mirror harness 64. At this point of time, the mirror harness-side part 92A of the in-vehicle body connector is not attached to another end of the mirror harness 64. Accordingly, where actuators 58 of a same type and mirror harnesses 64 of a same type are used between left and right mirrors or between different types of vehicles, even if a short-circuit structure is different between the left and right mirrors or between the different types of vehicles, it is not necessary to prepare, classify and manage actuator-mirror harness combinations with a finished short-circuit structure therein according to the left mirror and right mirrors or the vehicle types before the actuators and the mirror harnesses are incorporated into the remote-controlled mirrors.
(2) The other end of the mirror harness 64 is inserted through the hollow shaft 55 providing an axis of rotation of the mirror housing 54 relative to the mirror base 52.
(3) The actuator 58 is attached to the actuator connector 78.
(4) The actuator 58 is mounted in the mirror housing 54 directly or via a frame portion.
(5) The mirror harness-side part 92A is attached to the other end of the mirror harness 64. In other words, the terminal fittings 88 to 91 of the wires 66 to 69 in the mirror harness 64 are mounted in proper positions in the mounting spaces 121 to 124 of the mirror harness-side part 92A according to the vehicle type and the left mirror or the right mirror.
(6) If it is found out in an operation check after assembly of the remote-controlled mirror that some of the terminal fittings 88 to 91 are mounted in wrong positions in the mounting spaces 121 to 124, the ones of the terminal fittings 88 to 91 mounted in the wrong positions are pulled out from the mounting spaces and inserted into correct mounting spaces, thereby correcting the mounting positions.

A short-circuit structure of an in-vehicle body connector used in the present invention is not limited to that indicated in the embodiment, and various types of structures can be employed. Also, a mirror harness can include a bundle of various types of wires drawn out from a mirror unit such as wires for electrical retraction of a retractable mirror, wires for a mirror heater, wires for lamps included in a mirror and wires for a camera included in a mirror in addition to wires for a mirror angle adjustment actuator, and an in-vehicle body connector can be configured as one that connects the various types of wires all together to respective wires in the vehicle body harness.

### DESCRIPTION OF REFERENCE NUMERALS

44 . . . mirror angle adjustment controller, 46 . . . mirror switch circuit, 48 . . . door mirror (vehicle remote-controlled mirror), 50 . . . vehicle body, 52 . . . mirror base, 54 . . . mirror housing, 55 . . . hollow shaft, 58 . . . mirror angle adjustment actuator (actuator), 60, 62 . . . direct-current motor, 64 . . . mirror harness, 66, 67, 68, 69 . . . wire in mirror harness, 80, 81, 82, 83 . . . terminal of motor, 86 . . . vehicle body inner portion, 88, 89, 90, 91 . . . terminal fitting in mirror harness, 88b, 89b, 90b, 91b . . . spring contact piece, 92 . . . in-vehicle body connector, 92A . . . mirror harness-side part of in-vehicle body connector, 92B . . . vehicle body harness-side part of in-vehicle body connector, 106 . . . vehicle body harness, 107, 109 . . . second or third wire of vehicle body harness, 108 . . . first wire of vehicle body harness, 112, 113, 114 . . . terminal fitting of vehicle body harness, 121, 122, 123, 124 . . . mounting space, 127, 128, 129 . . . wall, 128a . . . cut of wall.

What is claimed is:

1. A remote-controlled mirror drive unit for supplying drive power to two direct-current motors in a mirror angle adjustment actuator in a vehicle remote-controlled mirror to electrically adjust a mirror angle vertically and horizontally, the drive unit comprising:
a mirror harness including four wires individually connected to four terminals of the two motors, the mirror harness being installed from an inner portion of a mirror housing of the remote-controlled mirror to an inner portion of a vehicle body through a mirror base;
a vehicle body harness including three wires including a first wire, a second wire and a third wire, the vehicle body harness being installed in the inner portion of the vehicle body;
a mirror switch circuit disposed in the inner portion of the vehicle body, to which power supply-side end portions of the three wires of the vehicle body harness are connected, the mirror switch circuit applying a motor drive voltage between the first wire and the second wire or between the first wire and the third wire from among the three wires selectively and with a polarity of the voltage reversibly changed according to a mirror angle adjustment operation of a mirror angle adjustment controller by a user; and
an in-vehicle body connector that interconnects four wires in the mirror harness and the three wires in the vehicle body harness, the connector including a mirror harness-side part to which terminal fittings of the four wires in the mirror harness are attached and a vehicle body harness-side part to which terminal fittings of the three wires in the vehicle body harness are attached, the in-vehicle body connector providing an electric conducting channel in which two of the four terminal fittings of the four wires in the mirror harness are connected in common to a terminal fitting of the first wire in the vehicle body harness, and remaining two of the four terminal fittings of the four wires in the mirror harness are individually connected to the second wire and the third wire in the vehicle body harness when the mirror harness-side part and the vehicle body harness-side part are interconnected.

2. The remote-controlled mirror drive unit according to claim 1, wherein the mirror harness-side part of the in-vehicle body connector includes mounting spaces in which the four terminal fittings in the mirror harness are mounted in such a manner that positions in which the four terminal fittings are mounted can be interchanged, and includes a structure that short-circuits terminal fittings mounted in particular two positions from among the mounting spaces.

3. The remote-controlled mirror drive unit according to claim 2, wherein the four terminal fittings each include a spring contact piece on respective side surfaces thereof, the mirror harness-side part of the in-vehicle body connector includes walls separating the mounting spaces in which the four terminal fittings are mounted, one particular wall from among the walls includes a cut, and the spring contact piece comes into contact with an adjacent terminal fitting through the cut, thereby short-circuiting the adjacent terminal fittings.

4. A method for assembling a remote-controlled mirror including the drive unit according to claims 1, the method comprising:
a first step of inserting the mirror harness with the mirror harness-side part of the in-vehicle body connector not attached thereto through a hollow shaft that provides a shaft of rotation of the mirror housing relative to the mirror base, connecting an end portion on the mirror housing side of the mirror harness to the mirror angle adjustment actuator and mounting the mirror angle adjustment actuator in the inner portion of the mirror housing; and
a second step of, after the first step, attaching an end on the vehicle body inner portion side of the mirror harness to the mirror harness-side part of the in-vehicle body connector to set two wires connected in common to the first wire in the vehicle body harness, and two wires individually connected to the second wire and the third wire in the vehicle body harness.

5. A method for assembling a remote-controlled mirror including the drive unit according to claims 2, the method comprising:
a first step of inserting the mirror harness with the mirror harness-side part of the in-vehicle body connector not attached thereto through a hollow shaft that provides a shaft of rotation of the mirror housing relative to the mirror base, connecting an end portion on the mirror housing side of the mirror harness to the mirror angle adjustment actuator and mounting the mirror angle adjustment actuator in the inner portion of the mirror housing; and
a second step of, after the first step, attaching an end on the vehicle body inner portion side of the mirror harness to the mirror harness-side part of the in-vehicle body connector to set two wires connected in common to the first wire in the vehicle body harness, and two wires individually connected to the second wire and the third wire in the vehicle body harness.

6. A method for assembling a remote-controlled mirror including the drive unit according to claims 3, the method comprising:
a first step of inserting the mirror harness with the mirror harness-side part of the in-vehicle body connector not attached thereto through a hollow shaft that provides a shaft of rotation of the mirror housing relative to the mirror base, connecting an end portion on the mirror housing side of the mirror harness to the mirror angle adjustment actuator and mounting the mirror angle adjustment actuator in the inner portion of the mirror housing; and
a second step of, after the first step, attaching an end on the vehicle body inner portion side of the mirror harness to the mirror harness-side part of the in-vehicle body connector to set two wires connected in common to the first wire in the vehicle body harness, and two wires individually connected to the second wire and the third wire in the vehicle body harness.
